(19) United States
(12) Patent Application Publication
(10) Pub. No.: US 2020/0277979 A1
(43) Pub. Date: Sep. 3, 2020

(54) SCREW COMPRISING ASSOCIATED SCREWDRIVER OR BIT

(71) Applicant: Mohammad Ali NAEEMI VALIPOUR, Nürnberg (DE)

(72) Inventor: Mohammad Ali NAEEMI VALIPOUR, Nürnberg (DE)

(21) Appl. No.: 16/647,353

(22) PCT Filed: May 5, 2018
(86) PCT No.: PCT/DE2018/000128

§ 371 Date: Mar. 13, 2020

(30) Foreign Application Priority Data
May 28, 2017 (DE) 20 2017 002 786.0
Oct. 28, 2017 (DE) 20 2017 005 611.9

(51) Int. Cl. F16B 23/00

(52) U.S. Cl. CPC F16B 23/0092

(57) ABSTRACT

A screw including an associated screwdriver or bit, wherein the screw head is designed in such a way that for any screwdrivers or bits, specifically having a slotted head, one-way slotted head, cross head (Phillips), torx, internal square (Robertson), internal hexagon (Inbus), torq-set, Pozidrive or tightener, sufficient contact surfaces are provided in order to transmit the torque from the screwdriver or bit to the screw head.

### FIELD OF THE INVENTION

The invention relates to a screw having an associated screwdriver or bit.

### Prior Art

DE 20 2007 016 004 U1 has disclosed screws with different screw heads, for example with a slot, a cross slot, a Torx head or an Inbus head. In order for it to be possible for said screws to be screwed into or out of a workpiece, four different screwdrivers or bits are required which fit into the different screw heads.

### OBJECT OF THE INVENTION

Proceeding from said prior art, the invention is based on the object of providing a screw of the type mentioned at the outset, the screw head of which screw is designed in such a way that the screw can be screwed in or out by way of most of the known screwdrivers or bits, namely a slot, a tamperproof slot, a cross slot (Phillips), a Torx head, a square drive (Robertson), a hexagon socket (Inbus), a Torq-set, a Pozidriv head or a Spanner head.

### Achievement of the Object

Said object is achieved by way of a screw having the features of the characterizing part of claim 1.

Further advantageous refinements of the invention are indicated in the subclaims.

### Advantages of the Invention

The advantages which are achieved by way of the invention consist, in particular, in that the screw can be screwed in and/or out by way of most of the standardized screwdrivers or bits. A further advantage consists in the high drive force on the contact faces between the screw and each of said screwdrivers or bits, even if smaller sizes of screwdrivers or bits are used.

### DESCRIPTION OF THE INVENTION

One exemplary embodiment of the invention is shown in the drawing and will be described in detail in the following text.

In the drawing:

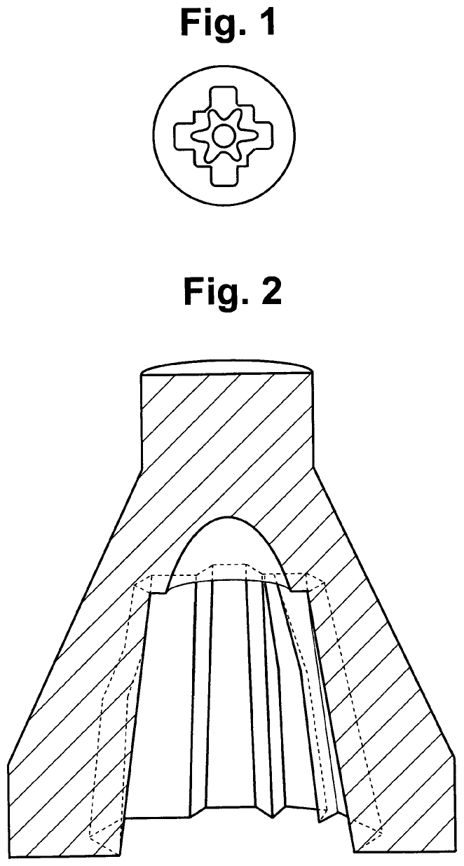

FIG. 1 shows a view from above of a screw head in accordance with the invention,

FIG. 2 shows a perspective sectional drawing of the screw head on an enlarged scale,

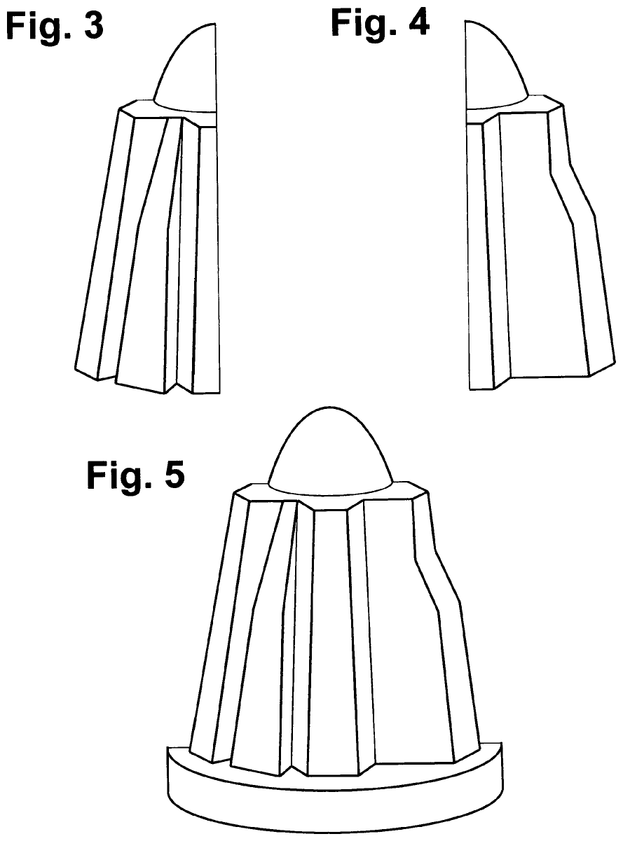

FIG. 3 shows a perspective view of one quarter of a negative impression of the screw head,

FIG. 4 shows a perspective view of that quarter of the negative impression of the screw head which lies next to the quarter in FIG. 3,

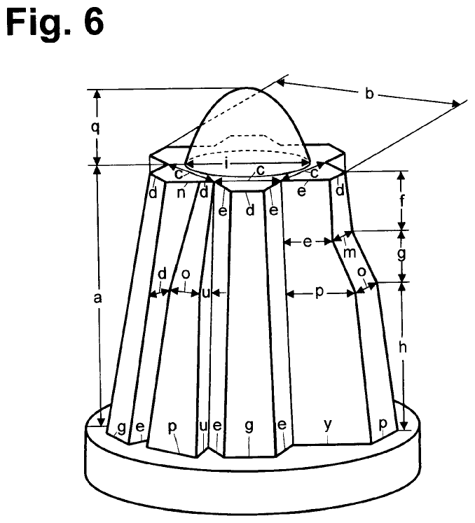

FIG. 5 shows a perspective view of the one half of the negative impression of the screw head, and

FIG. 6 shows a perspective view of the complete negative impression of the screw head.

FIG. 1 shows a view from above of a screw head in accordance with the invention which is shown in FIG. 2 as a perspective section on an enlarged scale.

FIGS. 3 to 5 in each case show two different quarters and one half of the screw head, to be precise as a negative impression which is obtained when the screw head is filled to the brim with a curable casting compound and the latter is removed after curing. In this way, the course of the various faces can be seen in an improved manner, in particular if said negative impression is halved and quartered. FIGS. 3 and 4 in each case show two quarters which lie next to one another and are shown in FIG. 5 as one of the two identical halves. The quarters which in each case lie diagonally opposite one another are identical to one another.

When the figures are considered, it can be seen clearly that the screw head is configured in such a way that there are contact faces which are sufficient for the transmission of the torque from the screwdriver or the bit to the screw head for screwdrivers with most bits, namely with a slot, a tamperproof slot, a cross slot (Phillips), a Torx head, a square drive (Robertson), a hexagon socket (Inbus), a Torq-set, a Pozidriv head or a Spanner head.

FIG. 6 indicates letters which relate to measurements, the ratios of which to one another are identical for all standardized screw sizes, to be precise as follows:

b=0.813 a
c=0.250 a
d=0.125 a
e=0.188 a
f=0.238 a
g=0.200 a
h=0.563 a
i=0.475 a
m=0.150 a
n=0.163 a
o=0.175 a
p=0.263 a
q=0.288 a
u=0.213 a
y=0.338 a

A further special feature consists in that screwdrivers or bits with the next smaller standard size, or else with even smaller standard sizes in the case of some screw types, also fit with sufficient rotary force into a screw head of a certain standard size, as indicated in the following tables for screws of the sizes T 40 and T 25.

| The following screwdrivers | | | |
|---|---|---|---|
| with smaller sizes fit | | | |
| for a screw of the size | | | |
| T 40 | | | |
| Torx | T 35 | T 30 | T 27 |
| Cross slot (Phillips) | PH 4 | PH 3 | PH 2 |
| Pozidriv | PZ 3 | PZ 2 | |
| Hexagon socket (Inbus) | H 5 | | |
| Square drive (Robertson) | S 4 | S 3 | |
| Slot | 1.2 × 7 | 1 × 6.5 | 1 × 6 |
| Torq-set | 10 | 8 | |
| Tamperproof slot | C 3 | C 2 | |

| The following screwdrivers | | | | |
|---|---|---|---|---|
| with smaller sizes fit | | | | |
| for a screw of the size | | | | |
| T 25 | | | | |
| Torx | T 20 | T 15 | AZ 25 | |
| Cross slot (Phillips) | PH 3 | PH 2 | PH 1 | |
| Pozidriv | PZ 2 | PZ 1 | | |
| Hexagon socket (Inbus) | V 1.8 | S 3 | K 3 | |
| Square drive (Robertson) | R 3 | S 1 | | |
| Slot | 5.5 | 5 | 4.5 | 4 |
| Torq-set | 8 | 7 | 6 | |
| Tamperproof slot | C 1 | | | |

1-5. (canceled)

6. A screw comprising: a screw head configured to have contact faces for transmission of torque from a screwdriver or a bit to the screw head for most types of screwdrivers and bits, including with a slot, a tamperproof slot, a cross slot (Phillips), a Torx head, a square drive (Robertson), a hexagon socket (Inbus), a Torq-set, a Pozidriv head or a Spanner head.

7. The screw according to claim 6, wherein the screw head is configured so that a negative impression of an interior of the screw head has two identical halves.

8. The screw according to claim 6, wherein the screw head is configured so that a negative impression of an interior of the screw head has two identical quarters that lie diagonally opposite one another.

9. The screw according to claim 6, wherein ratios of dimensions b to y firstly to a dimension of a height a, and secondly for standardized screw sizes are in each case identical, as follows:
b=0.813 a
c=0.250 a
d=0.125 a
e=0.188 a
f=0.238 a
g=0.200 a
h=0.563 a
i=0.475 a
m=0.150 a
n=0.163 a
o=0.175 a
p=0.263 a
q=0.288 a
u=0.213 a
y=0.338 a

10. The screw according to claim 6, wherein the screw head is configured so that screwdrivers or bits with a next smaller standard size or more also fit with sufficient rotary force into the screw head when the screw head is of a certain standard size.
